(19) United States
(12) Patent Application Publication
(10) Pub. No.: US 2025/0050783 A1
(43) Pub. Date: Feb. 13, 2025

(54) APPARATUS AND METHOD FOR PROVIDING INFORMATION ON DISTANCE TO EMPTY FOR A VEHICLE

(71) Applicants: HYUNDAI MOTOR COMPANY, Seoul (KR); KIA CORPORATION, Seoul (KR)

(72) Inventors: Kyeong Soo Song, Seoul (KR); Jin Hyung Lee, Seoul (KR); Seung Jae Yoo, Hwaseong-si (KR); Hyun Jong Ha, Hwaseong-si (KR); Jae Yeong Jeong, Hwaseong-si (KR); Eun Bin Kim, Seoul (KR); Seon Min Kim, Seoul (KR); Jong Hoon Ahn, Osan-si (KR)

(73) Assignees: HYUNDAI MOTOR COMPANY, Seoul (KR); KIA CORPORATION, Seoul (KR)

(21) Appl. No.: 18/414,065

(22) Filed: Jan. 16, 2024

(30) Foreign Application Priority Data
Aug. 10, 2023 (KR) 10-2023-0104563

(51) Int. Cl. B60L 58/12; B60W 50/14

(52) U.S. Cl. CPC B60L 58/12; B60W 50/14; B60L 2260/52; B60L 2260/54

(57) ABSTRACT

An apparatus provides information on a distance to empty (DTE) of a vehicle and an information providing method is performed thereby. The apparatus includes a display device configured to display DTE information of a vehicle and a controller configured to control operation of the display device. The controller determines low fuel efficiency-related information and high fuel efficiency-related information based on a current vehicle driving condition. The controller determines a low DTE value and a high DTE value based on the low fuel efficiency-related information, the high fuel efficiency-related information, and a current available battery energy. The controller also determines a current DTE value indicating a real-time DTE and controls operation of the display device to display the low DTE value, the high DTE value, and the current DTE value.

### CROSS-REFERENCE TO RELATED APPLICATION

This application claims under 35 U.S.C. § 119 (a) the benefit of priority to Korean Patent Application No. 10-2023-0104563 filed on Aug. 10, 2023, the entire contents of which are incorporated herein by reference.

### BACKGROUND

### (a) Technical Field

The present disclosure relates to an apparatus and method for providing information on a distance to empty of an electric vehicle to a driver by displaying the information through a display device such as an instrument cluster.

### (b) Background Art

In general, a vehicle is configured to perform a function of estimating a distance to empty (DTE) and providing the estimated DTE to a driver. For example, an internal combustion engine vehicle has a function of estimating a DTE based on a fuel level in a fuel tank and providing the estimated DTE to a driver through an instrument cluster.

Similarly, an electric vehicle, which travels by driving a motor using power of a battery, has a function of estimating a DTE based on the current remaining energy (state of charge) of the battery and displaying the estimated DTE on an instrument cluster.

Compared to internal combustion engine vehicles, the number of charging stations for electric vehicles is small, and the charging time is long. Therefore, drivers of electric vehicles are increasingly interested in DTE information.

Because drivers of electric vehicles are very sensitive to a DTE, it is important to accurately calculate a DTE of a vehicle corresponding to the remaining energy of a battery in real-time during travel and to notify a driver of the DTE.

As technology for providing information about a DTE of a vehicle, a method of estimating a DTE using the relationship between the remaining energy of a battery and energy efficiency (efficiency of use of electricity) is known. For example, U.S. Pat. No. 9,037,327 (Patent Document 1) discloses a method of calculating a DTE by determining energy efficiency (efficiency of use of electricity) using information accumulated from the past and multiplying the determined energy efficiency by the current remaining energy of a battery.

In addition, U.S. Pat. No. 9,574,889 (Patent Document 2) discloses a method of providing a DTE, in which a final DTE is determined by combining a value obtained by applying a weighted factor to a DTE calculated using past energy efficiency and a value obtained by applying a weighted factor to a DTE calculated using a currently designated route. The determined final DTE is updated when an event occurs. The disclosed method is a method of determining and updating a DTE using information accumulated from the past and information about an event ahead of a vehicle.

In Patent Document 1, a DTE is determined using past energy efficiency in order to resolve uncertainty in predicted future driving information. However, this is applicable on the assumption that the past energy efficiency will be maintained in the future. If future traffic conditions differ from past travel information, a large error may occur in energy efficiency calculated based on the past travel information.

In Patent Document 2, a DTE is updated whenever an event that consumes energy occurs. However, this may result in over-representation or under-representation of the influence of a corresponding event on a remaining travel route on the DTE.

Various other methods of estimating and predicting a DTE are known. Vehicle manufacturers use their own methods to estimate a DTE and provide the estimated DTE to a driver by displaying the same through an instrument cluster.

However, DTE prediction accuracy is not high. Thus, many consumers have complaints about DTE prediction quality. As conventional technology for resolving such complaints, a method of providing a minimum (MIN) DTE and a maximum (MAX) DTE as well as a current DTE through an instrument cluster is known.

However, this conventional technology has a problem in that the minimum DTE and the maximum DTE calculated based on a result of learning recent driving conditions greatly vary in a state in which it is impossible to predict conditions under which a driver will drive a vehicle in the future. Thus, it is difficult to accurately predict a DTE.

The above information disclosed in this Background section is only to enhance understanding of the background of the disclosure. Therefore, the Background section may contain information that does not form the related art that is already known to a person of ordinary skill in the art.

### SUMMARY

The present disclosure has been made in an effort to solve the above-described problems associated with the related art. Objects of the present disclosure are to provide an apparatus and a method for displaying not only information about a current real-time distance to empty (DTE) but also information about a low DTE and a high DTE calculated irrespective of learning, by which a vehicle is capable of typically traveling depending on a driving condition such as a region or a road.

In addition, other objects of the present disclosure are to provide a DTE display apparatus and a method capable of inducing a driver to drive economically.

The objects of the present disclosure are not limited to the objects mentioned above. Other objects not mentioned herein may be more clearly understood by those of ordinary skill in the art to which the present disclosure pertains from the following description.

In one aspect, the present disclosure provides an apparatus for providing information on a distance to empty (DTE) of a vehicle. The apparatus includes a display device configured to display DTE information of a vehicle and a controller configured to control the operation of the display device. The controller determines low fuel efficiency-related information and high fuel efficiency-related information according to a current vehicle driving condition. The controller also determines a low DTE value and a high DTE value based on the low fuel efficiency-related information, the high fuel efficiency-related information, and a current available battery energy. The controller also determines a current DTE value indicating a real-time DTE and controls operation of the display device to display the low DTE value, the high DTE value, and the current DTE value.

In another aspect, the present disclosure provides a method of providing information on a distance to empty (DTE) of a vehicle. The method includes determining, by a controller, low fuel efficiency-related information and high fuel efficiency-related information according to a current vehicle driving condition. The method also includes determining, by the controller, a low DTE value and a high DTE value based on the low fuel efficiency-related information, the high fuel efficiency-related information, and a current available battery energy. The method also includes determining, by the controller, a current DTE value indicating a real-time DTE and controlling, by the controller, operation of a display device to display the low DTE value, the high DTE value, and the current DTE value.

Other aspects and embodiments of the disclosure are discussed below.

It is understood that the terms “vehicle” or “vehicular” or other similar terms as used herein are inclusive of motor vehicles in general. Such motor vehicles may encompass passenger automobiles including sport utility vehicles (SUV), buses, trucks, various commercial vehicles, watercraft including a variety of boats and ships, aircraft, and the like. Such motor vehicles may also include hybrid vehicles, electric vehicles, plug-in hybrid electric vehicles, hydrogen-powered vehicles and other alternative fuel vehicles (e.g., fuels derived from resources other than petroleum). As referred to herein, a hybrid vehicle is a vehicle that has two or more sources of power, for example, a vehicle that is both gasoline-powered and electric-powered.

The above and other features of the disclosure are discussed below.

### BRIEF DESCRIPTION OF THE DRAWINGS

The above and other features of the present disclosure are described in detail with reference to certain embodiments thereof illustrated in the accompanying drawings, which are given hereinbelow by way of illustration only, and thus are not limitative of the present disclosure, and wherein:

FIGS. 1A, 1B, and 1C are diagrams showing examples in which a low DTE value, a high DTE value, and a current DTE value are displayed as graphic images on a display device in the present disclosure;

FIGS. 2A, 2B, and 2C are diagrams showing examples in which a low DTE, a high DTE, and a current DTE are displayed on an instrument cluster of a vehicle in the present disclosure;

FIG. 3 is a diagram showing the configuration of an apparatus that performs a DTE information providing process according to the present disclosure; and

FIG. 4 is a diagram showing a method of determining the low DTE value and the high DTE value according to the present disclosure.

It should be understood that the appended drawings are not necessarily drawn to scale, presenting a somewhat simplified representation of various features illustrative of the basic principles of the disclosure. The specific design features of the present disclosure as disclosed herein, including, for example, specific dimensions, orientations, locations, and shapes, will be determined in part by the particular intended application and use environment.

In the figures, the same reference numbers refer to the same or equivalent parts of the present disclosure throughout the several figures of the drawings.

### DETAILED DESCRIPTION

Various embodiments are described more fully with reference to the accompanying drawings, in which only some embodiments are shown. Specific structural and functional details disclosed herein are merely representative for the purpose of describing embodiments. Embodiments of the present disclosure, however, may be embodied in many alternate forms, and should not be construed as being limited only to the embodiments set forth herein. Accordingly, while embodiments of the disclosure are capable of being variously modified and taking alternative forms, embodiments thereof are shown by way of example in the drawings and are herein described in detail. It should be understood, however, that there is no intent to limit the present disclosure to the particular embodiments disclosed. On the contrary, embodiments are to cover all modifications, equivalents, and alternatives falling within the scope of the disclosure.

It should be understood that, although the terms “first”, “second”, and the like. may be used herein to describe various elements, these elements should not be limited by these terms. These terms are only used to distinguish one element from another. For example, a first element could be termed a second element, and, similarly, a second element could be termed a first element, without departing from the scope of the embodiments of the present disclosure.

It should be understood that, when an element is referred to as being “connected” or “coupled” to another element, it can be directly connected or coupled to the other element, or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between”, “adjacent” versus “directly adjacent”, and the like).

Wherever possible, the same reference numbers are used throughout the drawings to refer to the same or like parts. The terminology used herein is for the purpose of describing particular embodiments only and is not intended to be limiting of embodiments of the disclosure. As used herein, the singular forms “a”, “an”, and “the” are intended to include the plural forms as well, unless the context clearly indicates otherwise. It should be further understood that the terms “comprises”, “comprising”, “includes”, and/or “including”, and variations thereof, when used herein, specify the presence of stated components, steps, operations, and/or elements, but do not preclude the presence or addition of one or more other components, steps, operations, and/or elements. When a component, device, element, or the like of the present disclosure is described as having a purpose or performing an operation, function, or the like, the component, device, or element should be considered herein as being “configured to” meet that purpose or to perform that operation or function.

The present disclosure relates to an information providing apparatus and method for providing information about a distance to empty (DTE) to a driver of an electric vehicle by displaying the information. Driving output is calculated using a low-DTE vehicle speed and a high-DTE vehicle speed. These speeds are set according to a vehicle driving condition such as a region and a road. Driving output is also calculated using constant-speed fuel economy information obtained from the specifications of the vehicle and using information about a low DTE and a high DTE by which the vehicle is capable of typically traveling depending on a driving condition such as a region or a road irrespective of learning is obtained using the calculated driving output and is provided.

According to the present disclosure, the information about the low DTE and the high DTE, which vary depending on a change in the available energy (remaining energy) of a battery, is provided through a display device of the vehicle, such as an instrument cluster. Also, a current DTE reflecting a driver's driving pattern and a current vehicle driving state is also provided in real-time to the driver through the instrument cluster. The driver may thereby be induced to drive economically so that the current real-time DTE (hereinafter referred to as the “current DTE”) moves to and converges on the high DTE.

The low DTE and the high DTE provided by the present disclosure is information unrelated to learning and may be values that vary depending on a change of available battery energy irrespective of the driver's driving pattern and learning.

According to the present disclosure, not only the current DTE value but also the low DTE value and the high DTE value calculated based on the available battery energy are displayed through a display device such as an instrument cluster. Accordingly, the driver may check the low DTE value, the high DTE value, and the current DTE value located between the low DTE value and the high DTE value, which are displayed on the display device, in real-time while driving the vehicle. The driver also may drive the vehicle so that the current DTE value approaches the high DTE value, rather than the low DTE value.

Prior to describing a method of defining and calculating the low DTE, the high DTE, and the current DTE, a method of displaying DTE information, such as the low DTE, the high DTE, and the current DTE, through a display device such as an instrument cluster are now described in detail.

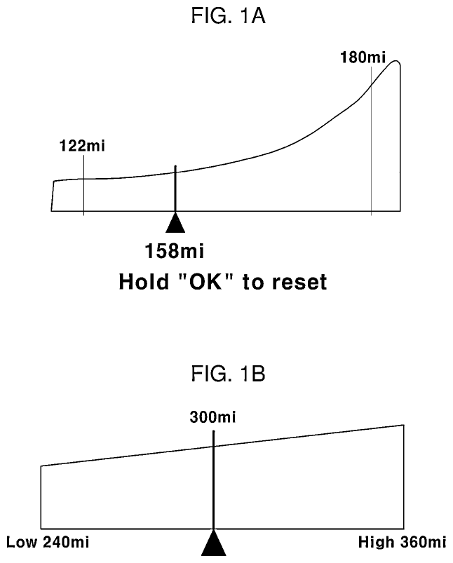

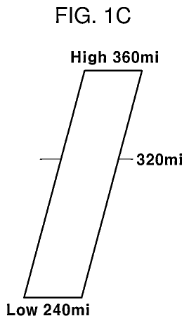

FIGS. 1A, 1B, and 1C are diagrams showing examples in which the low DTE, the high DTE, and the current DTE are displayed on a display device. As illustrated, the low DTE value, the high DTE value, and the current DTE value may be displayed as numerical values on the display device.

Alternatively, the low DTE value, the high DTE value, and the current DTE value may be displayed as relative positions on a graphic image displayed on the display device. In this case, the numerical values and the relative positions on the graph image indicating the low DTE value, the high DTE value, and the current DTE value may be selectively displayed or may be displayed together.

The display ways of the low DTE, the high DTE, and the current DTE shown in FIGS. 1A, 1B, and 1C are merely illustrative, and the present disclosure is not limited thereto. According to the present disclosure, the low DTE, the high DTE, and the current DTE may be displayed in various other ways.

The numerical values and the relative positions on the graph image indicating the DTE information, such as the low DTE value, the high DTE value, and the current DTE value, may be displayed together on the display device so that the driver intuitively recognizes the position of the current DTE value between the low DTE value and the high DTE value.

Accordingly, the driver may easily compare the current DTE value with the low DTE value and the high DTE value and may easily check the degree of current DTE value compared to the low DTE value and the high DTE value.

According to the present disclosure, the low DTE, the high DTE, and the current DTE may be real-time information that is obtained based on current information and varies. The values thereof displayed during travel of the vehicle vary in real-time.

In detail, the low DTE and the high DTE are determined based on the current available battery energy, and the values thereof vary depending on a change of the available battery energy irrespective of the driver's driving pattern and learning.

On the other hand, the current DTE is information that is learned, and the value thereof varies in real-time depending on the driver's driving pattern, the vehicle driving condition (e.g., driving on uphill/downhill roads), and the vehicle driving state (e.g., a driving speed of the vehicle).

Since the low DTE value, the high DTE value, and the current DTE value, which vary in real-time during travel of the vehicle, are displayed as graphic images through the instrument cluster of the vehicle, the driver may intuitively recognize, through the graphic images, that the current DTE value, which is calculated based on the real-time vehicle driving condition and the vehicle driving state, approaches the low DTE value or the high DTE value between the low DTE value and the high DTE value, which vary depending on a change of the current available battery energy. Accordingly, the driver may control the vehicle driving state so that the current DTE value approaches the high DTE value while checking the graphic images indicating the DTE values. In other words, the driver may drive the vehicle economically.

Referring to FIG. 1A, the low DTE and the high DTE are displayed at a left side and a right side of a graph-shaped image, respectively, and the values thereof are displayed as numerical values.

In addition, the values of the low DTE and the high DTE are displayed at the positions of the low DTE and the high DTE as heights of the graph that represent the size of the graph image to be easily compared with each other. Accordingly, the driver may check and compare the values of the low DTE, the high DTE, and the current DTE using the displayed numerical values, the displayed position of the current DTE value relative to the low DTE value and the high DTE value, and the heights of the graph at the displayed positions of the respective DTE values.

Alternatively, the values of the low DTE, the high DTE, and the current DTE may be displayed as colors of the graphic image on the display device so as to be easily compared with each other. In this case, the driver may easily check the degree of current DTE value between the low DTE value and the high DTE value using the distinguishable and comparable colors.

According to the present disclosure, the current DTE is not always located at the center between the low DTE and the high DTE but moves in the space between the low DTE and the high DTE. The value of the current DTE is shown to the driver by displaying the position of the current DTE relative to the low DTE and the high DTE.

If the driver drives economically, the current DTE may move to the high DTE, and if the vehicle driving condition is poor in terms of efficiency of use of electricity (fuel efficiency), the current DTE may move to the low DTE. Accordingly, the present disclosure may induce the driver to drive economically so that the current DTE moves to the high DTE.

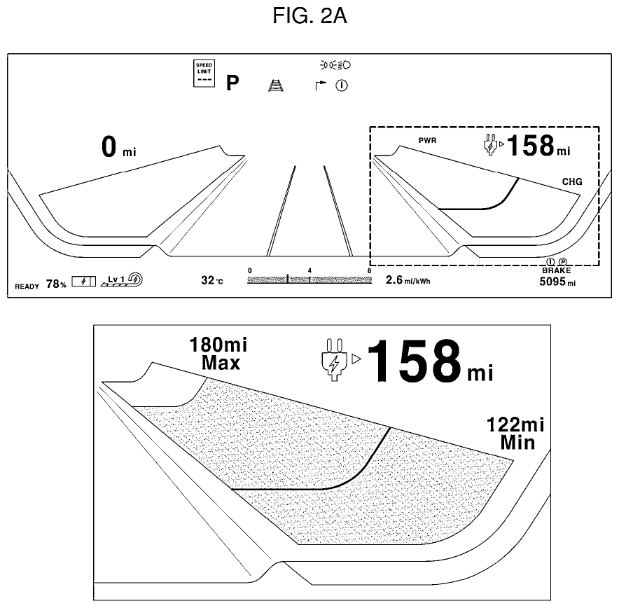

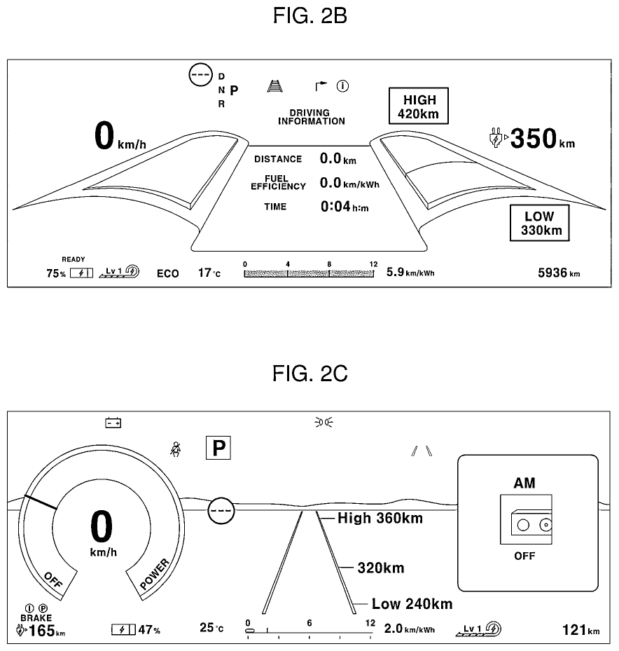

In FIG. 1A, the position at which the numerical value indicating the current DTE value is displayed moves left or right as the current DTE value changes. In other words, whenever the current DTE value is updated and changed at predetermined intervals, the display position of the numerical value indicating the current DTE value moves between the low DTE value and the high DTE value. This operation is also performed not only in the examples shown in FIGS. 1B and 1C but also in the examples shown in FIGS. 2A, 2B, and 2C to be described later.

In FIG. 1A, the minimum DTE (i.e., the low DTE) value is displayed as “122 mi”, the maximum DTE (i.e., the high DTE) value is displayed as “180 mi”, and the current DTE value is displayed as “158 mi”. The minimum DTE value and the maximum DTE value are values that are periodically obtained and updated during travel of the vehicle, and the current DTE value is also a value that is updated in real-time.

In FIG. 1B, the minimum DTE (i.e., the low DTE) value is displayed as “Low 240 mi”, the maximum DTE (i.e., the high DTE) value is displayed as “High 360 mi”, and the current DTE value is displayed as “300 mi”. As the current DTE value changes during travel of the vehicle, the display position of the numerical value indicating the current DTE value moves left or right in the drawing.

FIG. 1C shows an example in which the display position of the numerical value indicating the current DTE value (“320 mi”) moves up or down between the low DTE value (“Low 240 mi”) and the high DTE value (“High 360 mi”) as the current DTE value changes.

FIGS. 2A, 2B, and 2C are diagrams showing examples in which the low DTE, the high DTE, and the current DTE are displayed on the instrument cluster of the vehicle. As illustrated, the low DTE value (“122 mi Min” in FIG. 2A), the high DTE value (“180 mi Max” in FIG. 2A), and the current DTE value may be displayed on the instrument cluster together with information typically displayed on the cluster.

When the low DTE value, the high DTE value, and the current DTE value are displayed on the instrument cluster, numerical values indicating the DTE values are displayed in different sizes at different positions together with typical cluster information.

Hereinafter, a method of determining the low DTE and the high DTE is described.

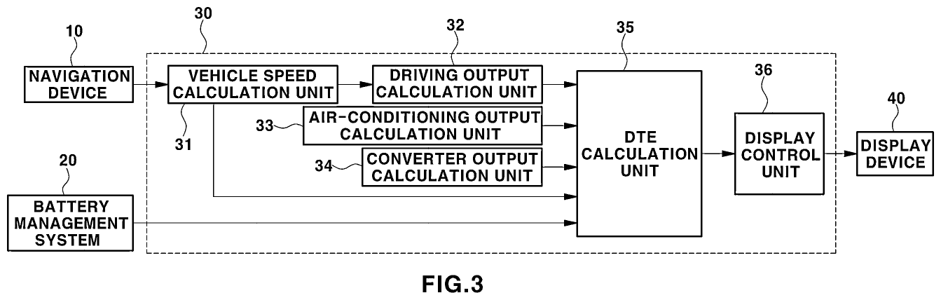

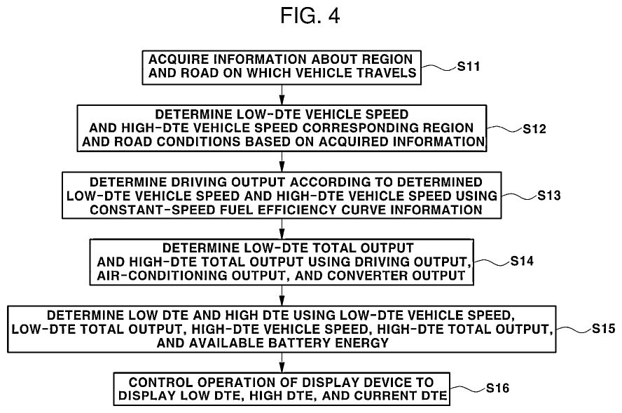

FIG. 3 is a diagram showing the configuration of an apparatus that performs a DTE information providing process according to the present disclosure, and FIG. 4 is a diagram showing a method of determining the low DTE value and the high DTE value according to the present disclosure.

The process shown in FIG. 4 is performed by the controller 30 shown in FIG. 3. The low DTE, the high DTE, and the current DTE are calculated and obtained in real-time by the controller 30. In addition, information about the low DTE, the high DTE, and the current DTE determined by the controller 30 may be displayed on a display device 40 in any of the forms illustrated in FIGS. 1A, 1B, 1C, 2A, 2B, and 2C to be provided to the driver.

In the present disclosure, a control process for providing DTE information may be performed by a plurality of controllers that perform cooperative control while exchanging necessary information with each other or may be performed by a single integrated controller.

For example, the plurality of controllers may include a vehicle control unit (VCU), which is a high-level controller, a heating, ventilation, and air-conditioning (HVAC) controller, and a battery management system (BMS), and may further include a converter controller.

Here, the converter controller may be a converter that converts battery power and outputs the converted battery power to electronic components of the vehicle (i.e., a controller of a low-voltage DC-DC converter (LDC)).

In the present disclosure, the plurality of controllers and the single controller having the integrated function may be collectively referred to as a controller, and the control process of the present disclosure may be performed by the collectively called controller. In the following description, the “controller” is the collectively called controller, unless specified otherwise.

Referring to FIG. 3, the controller 30 includes a vehicle speed calculation unit 31, a driving output calculation unit 32, an air-conditioning output calculation unit 33, a converter output calculation unit 34, a DTE calculation unit 35, and a display control unit 36. The controller 30 including the above units is the single controller having the integrated function.

Alternatively, in the case in which the control process according to the present disclosure is performed by a plurality of controllers provided in the vehicle, the air-conditioning output calculation unit 33 may be an HVAC controller, which is a separate controller, and the converter output calculation unit 34 may be a converter controller, which is a separate controller. Alternatively, the display control unit 36 may be a display controller, which is a separate controller connected to or included in the display device 40 in order to control operation of the display device 40.

The vehicle speed calculation unit 31, the driving output calculation unit 32, and the DTE calculation unit 35 may also be components included in a separate controller, for example, a vehicle control unit (VCU).

In this case, the air-conditioning controller, the converter controller, and the display controller, including the vehicle speed calculation unit 31, the driving output calculation unit 32, and the DTE calculation unit 35, may be collectively referred to as a controller. The control process for providing DTE information according to the present disclosure may be performed by the collectively called controller.

According to the present disclosure, the DTE calculation unit 35 of the controller 30 may determine the low DTE and the high DTE using the current available battery energy.

In more detail, the DTE calculation unit 35 of the controller 30 may calculate the low DTE using low fuel efficiency-related information and the current available battery energy. In addition, the DTE calculation unit 35 of the controller 30 may calculate the high DTE using high fuel efficiency-related information and the current available battery energy.

The low fuel efficiency-related information includes a low-DTE vehicle speed according to the current vehicle driving condition and a low-DTE total output, which is a total battery output at the low-DTE vehicle speed.

In addition, the high fuel efficiency-related information includes a high-DTE vehicle speed according to the current vehicle driving condition and a high-DTE total output, which is a total battery output at the high-DTE vehicle speed.

The DTE calculation unit 35 may calculate the low DTE using the low fuel efficiency-related information, including the low-DTE vehicle speed and the low-DTE total output, and the current available battery energy.

In addition, the DTE calculation unit 35 may calculate the high DTE using the high fuel efficiency-related information, including the high-DTE vehicle speed and the high-DTE total output, and the current available battery energy.

Here, the low-DTE total output may be a total battery output at the low-DTE vehicle speed, and the high-DTE total output may be a total battery output at the high-DTE vehicle speed.

In an embodiment of the present disclosure, the low DTE may be determined to be a value obtained by multiplying a value, obtained by dividing the low-DTE vehicle speed by the low-DTE total output, by the current available battery energy. The high DTE may be determined to be a value obtained by multiplying a value, obtained by dividing the high-DTE vehicle speed by the high-DTE total output, by the current available battery energy.

The low DTE and the high DTE may be expressed using Equations 1 and 2 below.

$$Low DTE = ( Low - DTE Vehicle Speed ) / ( Low - DTE Total Output ) \times ( Available Battery Energy ) \qquad [ Equation 1 ]$$

$$High DTE = ( High - DTE Vehicle Speed ) / ( High - DTE Total Output ) \times ( Available Battery Energy ) \qquad [ Equation 2 ]$$

The low-DTE vehicle speed and the high-DTE vehicle speed may be determined by the vehicle speed calculation unit 31 of the controller 30 (step S12 in FIG. 4). As the low-DTE vehicle speed and the high-DTE vehicle speed, values preset in the vehicle speed calculation unit 31 according to the vehicle driving condition may be used. In detail, the values may be preset according to a region condition and a road condition. In other words, the vehicle speed calculation unit 31 may determine the low-DTE vehicle speed and the high-DTE vehicle speed according to corresponding region and road conditions.

If the controller 30 that calculates the low DTE and the high DTE using Equations 1 and 2 is a vehicle control unit, the vehicle control unit may be used to receive real-time available battery energy information from the battery management system (BMS) 20 in order to calculate the low DTE and the high DTE.

In an embodiment of the present disclosure, the vehicle driving condition includes a region condition and a road condition in which the vehicle travels. In addition, in the present disclosure, the low-DTE vehicle speed is a vehicle speed that may provide a short DTE (low DTE) depending on a region condition and a road condition. The high-DTE vehicle speed is a vehicle speed that may provide a long DTE (high DTE) depending on a region condition and a road condition.

In an embodiment of the present disclosure, the low-DTE vehicle speed and the high-DTE vehicle speed are values preset according to a region condition and a road condition. In detail, low-DTE vehicle speeds and high-DTE vehicle speeds corresponding to respective region conditions and road conditions are input and stored in advance in the vehicle speed calculation unit 31 of the controller 30.

Accordingly, the vehicle speed calculation unit 31 of the controller 30 may determine a low-DTE vehicle speed and a high-DTE vehicle speed corresponding to a region and a road on which the vehicle is currently traveling based on information about matching between the low-DTE and high-DTE vehicle speeds and the region and road conditions.

In this case, the vehicle speed calculation unit 31 of the controller 30 may acquire information about the region and the road on which the vehicle is currently traveling from navigation information output from a navigation device 10 (step S11 in FIG. 4).

In other words, the controller 30 may acquire information about the region condition and the road condition for determination of the low-DTE vehicle speed and the high-DTE vehicle speed from current vehicle location information and current vehicle traveling road information included in the navigation information output from the navigation device 10.

Table 1 below shows an example of setting the low-DTE vehicle speed and the high-DTE vehicle speed. The values of the low-DTE vehicle speed and the high-DTE vehicle speed are merely illustrative, and the present disclosure is not limited thereto. The low-DTE vehicle speed and the high-DTE vehicle speed may have various values depending on a region condition and a road condition.

TABLE 1

| | |
|---|---|
| Korea/Europe | North America |

| | Low-DTE | High-DTE | Low-DTE | High-DTE |
|---|---|---|---|---|
| | Vehicle | Vehicle | Vehicle | Vehicle |
| | Speed | Speed | Speed | Speed |
| | [km/hr] | [km/hr] | [km/hr] | [km/hr] |
| Highway | 120 | 80 | 130 | 90 |
| City Road | 100 | 60 | 110 | 70 |

As illustrated in Table 1, an average vehicle speed on a highway is higher than that on a city road, and an average vehicle speed in North America is higher than that in Korea or Europe. In general, the higher the average vehicle speed, the longer the DTE. Therefore, as the average vehicle speed according to a region condition and a road condition increases, the low-DTE vehicle speed and the high-DTE vehicle speed may be set to higher values.

In addition, referring to Table 1, it can be seen that, because the low-DTE vehicle speed is a vehicle speed that may provide a short DTE (low DTE), the low-DTE vehicle speed is set to a value higher than the high-DTE vehicle speed that may provide a long DTE (high DTE). When the vehicle travels at high speed, the DTE is shorter than when the vehicle travels at low speed. For this reason, the low-DTE vehicle speed that may provide a short DTE is set to a value higher than the high-DTE vehicle speed that may provide a long DTE.

In an embodiment of the present disclosure, each of the low-DTE total output and the high-DTE total output is a total battery output, and may be determined to be a value obtained by summing, by the DTE calculation unit 35 of the controller 30, a driving output and an air-conditioning output, or may be determined to be a value obtained by summing a driving output, an air-conditioning output, and a converter output.

The driving output is a battery output used by a motor in order to drive the vehicle. The driving output is determined to be a value corresponding to the high-DTE vehicle speed or the low-DTE vehicle speed, which is an appropriate vehicle speed according to a region condition and a road condition, by the driving output calculation unit 32 of the controller 30 (step S13 in FIG. 4). The driving output is input to the DTE calculation unit 35.

In addition, the air-conditioning output is determined by the air-conditioning output calculation unit 33 and is input to the DTE calculation unit 35. Also, the converter output is determined by the converter output calculation unit 34 and is input to the DTE calculation unit 35.

The air-conditioning output is a battery output used for air-conditioning and the converter output is a battery output used for electronic components. The converter output may be an output of the LDC, which converts battery power and outputs the converted battery power to the electronic components of the vehicle.

In an embodiment of the present disclosure, there is no distinction between a low DTE and a high DTE for the air-conditioning output or the LDC output, but there is a distinction between a low DTE and a high DTE for the driving output. In other words, the driving output includes a low-DTE driving output and a high-DTE driving output. The low-DTE driving output is used for the DTE calculation unit 35 to calculate the low-DTE total output, and the high-DTE driving output is used for the DTE calculation unit 35 to calculate the high-DTE total output (step S14 in FIG. 4).

The driving output calculation unit 32 of the controller 30 may determine the low-DTE driving output or the high-DTE driving output using an equation having the low-DTE vehicle speed or the high-DTE vehicle speed output from the vehicle speed calculation unit 31 as an input variable. The equation may be a cubic equation as a “vehicle speed-driving output” relational expression defining a correlation between the vehicle speed and the driving output.

Equation 3 below is a cubic equation for calculating the driving output, i.e., the low-DTE driving output or the high-DTE driving output, from the low-DTE vehicle speed or the high-DTE vehicle speed.

$$Driving Output = {a}_{1} \times ( Vehicle Speed ) + {a}_{2} \times {( Vehicle Speed )}^{2} + {a}_{3} \times {( Vehicle Speed )}^{3} \qquad [ Equation 3 ]$$

Equation 3 above is a cubic equation representing a constant-speed fuel efficiency curve. At the vehicle development stage, constant-speed fuel efficiency tests and evaluations may be conducted on a corresponding vehicle to determine the cubic equation of “vehicle speed-driving output” and to obtain the coefficients a₁, a₂, and a₃ of the cubic equation.

In Equation 3, the coefficients a₁, a₂, and a₃, which are set information for the equation of constant-speed fuel efficiency curve, are vehicle-specific values that represent the characteristics of the vehicle specifications. The coefficients a₁, a₂, and a₃ may be obtained through constant-speed fuel efficiency tests and evaluations for a corresponding vehicle.

In the present disclosure, the coefficients of the constant-speed fuel efficiency curve are input and stored in advance in the driving output calculation unit 32 of the controller 30. The coefficients are used to calculate the driving output from an appropriate vehicle speed corresponding to the current region condition and road condition through the equation of constant-speed fuel efficiency curve.

In other words, the above coefficients may be used to calculate the low-DTE driving output or the high-DTE driving output from the low-DTE vehicle speed or the high-DTE vehicle speed through the equation of constant-speed fuel efficiency curve.

Equation 4 below is a cubic equation of constant-speed fuel efficiency curve for calculating the low-DTE driving output from the low-DTE vehicle speed. Equation 5 below is a cubic equation of constant-speed fuel efficiency curve for calculating the high-DTE driving output from the high-DTE vehicle speed.

$$Low - DTE Driving Output = {a}_{1} \times ( Low - DTE Vehicle Speed ) + {a}_{2} \times {( Low - DTE Vehicle Speed )}^{2} + {a}_{3} \times {( Low - DTE Vehicle Speed )}^{3} \qquad [ Equation 4 ]$$

$$High - DTE Driving Output = {a}_{1} \times ( High - DTE Vehicle Speed ) + {a}_{2} \times {( High - DTE Vehicle Speed )}^{2} + {a}_{3} \times {( High - DTE Vehicle Speed )}^{3} \qquad [ Equation 5 ]$$

As described above, the DTE calculation unit 35 of the controller 30 may determine each of the low-DTE total output and the high-DTE total output, which mean the total battery output, to be a sum of the driving output input thereto from the driving output calculation unit 32 and the air-conditioning output input thereto from the air-conditioning output calculation unit 33. In this case, calculation of the air-conditioning output by the air-conditioning output calculation unit 33 may be performed through a well-known air-conditioning output calculation process using an air-conditioning thermal model.

Accordingly, the DTE calculation unit 35 of the controller 30 may determine the low-DTE total output to be a sum of the low-DTE driving output and the air-conditioning output and may determine the high-DTE total output to be a sum of the high-DTE driving output and the air-conditioning output (step S14 in FIG. 4).

Alternatively, the converter output, which means the battery output for the electronic components of the vehicle, may be further used to determine the total output. As described above, the converter output that is output from the converter output calculation unit 34 may be the LDC output.

Accordingly, the DTE calculation unit 35 of the controller 30 may determine the low-DTE total output to be a sum of the low-DTE driving output, the air-conditioning output, and the LDC output, and may determine the high-DTE total output to be a sum of the high-DTE driving output, the air-conditioning output, and the LDC output (step S14 in FIG. 4).

In an embodiment of the present disclosure, a learning value may be used as the LDC output, and a new LDC output value is stored in the converter output calculation unit 34 of the controller 30 at an interval of 1 kilometer (km) in order to learn the driver's driving pattern.

In detail, the converter output calculation unit 34 of the controller 30 has “n” buffers and the LDC output value is stored in one of the “n” buffers (e.g., n=25) at an interval of 1 km. In this case, one of the values stored in the “n” buffers is updated to a new LDC output value at an interval of 1 km.

In addition, among the “n” values stored in the “n” buffers, the LDC output values recently stored in “m” buffers (e.g., m=10) may be averaged, and the average value may be used as a final LDC output value.

Table 2 below shows an example of calculating the LDC output values.

TABLE 2

| Buffer No. | 1 | 2 | . . . | 16 | 17 | 18 | 19 | 20 | 21 | 22 | 23 | 24 | 25 |
|---|---|---|---|---|---|---|---|---|---|---|---|---|---|
| LDC Output | 0.70 | 0.71 | . . . | 0.67 | 0.68 | 1.01 | 1.03 | 1.02 | 0.52 | 0.51 | 0.53 | 0.51 | 0.46 |
| [kW] | | | | | | | | | | | | | |

In the example shown in Table 2, an LDC output value, which is updated every predetermined distance (e.g., 1 km), is stored in each of a total of 25 buffers. Among the total of 25 LDC output values sequentially stored in the buffers, the LDC output values recently stored in 10 buffers are averaged, and the average value is used as a final LDC output value.

In the example shown in Table 2, the average value of the LDC output values stored in the 16th to 25th buffers is 0.70 kilowatts (KW). This average value is determined to be a final LDC output value.

In this way, the LDC output may be learned. However, since the LDC output is smaller than the driving output and the air-conditioning output and a fluctuation range of the LDC output is also relatively small, a fixed value, rather than a learning value, may be used as the LDC output value. In other words, a value preset for a corresponding vehicle may be used as the LDC output value.

After the low-DTE total output and the high-DTE total output are obtained through the above-described process by the DTE calculation unit 35 of the controller 30, the low DTE value and the high DTE value may be obtained through Equations 1 and 2 using the low-DTE and high-DTE total outputs, the low-DTE and high-DTE vehicle speeds output from the vehicle speed calculation unit 31, and the available battery energy output from the battery management system 20 (step S15 in FIG. 4).

Table 3 below shows an example in which the low DTE and the high DTE of a certain vehicle are obtained according to a region condition and a road condition.

TABLE 3

| | Korea/Europe | | | | North America | | | |
|---|---|---|---|---|---|---|---|---|
| | Low-DTE | | High-DTE | | Low-DTE | | High-DTE | |
| | Vehicle | | Vehicle | | Vehicle | | Vehicle | |
| | Speed | Low DTE | Speed | High DTE | Speed | Low DTE | Speed | High DTE |
| Highway | 120 | 274 | 80 | 415 | 130 | 244 | 90 | 379 |
| City | 100 | 343 | 60 | 466 | 110 | 307 | 70 | 445 |
| Road | | | | | | | | |

When the values of the low DTE and the high DTE are determined, the display control unit 36 of the controller 30 controls operation of the display device 40 to display the low DTE value, the high DTE value, and the current DTE value on the display device 40 in a predetermined manner (step S16 in FIG. 4).

In this case, the operation of the display device 40 may be controlled such that the low DTE value, the high DTE value, and the current DTE value are displayed in any of the forms illustrated in FIGS. 1A, 1B, 1C, 2A, 2B, and 2C.

The current DTE is calculated by taking into consideration the driver's driving pattern and the current vehicle driving state. The current DTE may be calculated through a well-known method.

There are various methods of calculating the current DTE in real-time during travel of a vehicle using the driver's driving pattern related to acceleration and deceleration and real-time vehicle driving state information, such as a road state (e.g., an uphill road or a downhill road) or a current vehicle speed, and one of the well-known methods may be used.

Since various methods of calculating a current DTE in real-time are known to those of ordinary skill in the art to which the present disclosure pertains, a detailed description of the method of calculating the current DTE is omitted in this specification.

The display control unit 36 of the controller 30 controls operation of the display device 40 to display the current DTE value determined in this way together with the low DTE value and the high DTE value. In this case, these DTE values may be displayed to be provided to the driver, as described above with reference to FIGS. 1A-1C and 2A-2C.

As is apparent from the above description, according to the apparatus and method for providing information on a DTE of a vehicle according to the present disclosure, not only a low DTE and a high DTE calculated irrespective of learning, but also a current DTE reflecting a driver's driving pattern and a current vehicle driving state is displayed in real-time through a display device such as an instrument cluster to be provided to the driver. The driver may thereby be induced to drive economically so that the current DTE moves to and converges on the high DTE.

The present disclosure has been described above with reference to various embodiments. The embodiments described in the specification and shown in the accompanying drawings are illustrative only and are not intended to represent all aspects of the disclosure. Therefore, the present disclosure is not limited to the embodiments presented herein. It is to be understood by those of ordinary skill in the art that various modifications or changes can be made without departing from the technical spirit or scope of the disclosure as disclosed in the appended claims.

What is claimed is:

1. An apparatus for providing information on a distance to empty (DTE) of a vehicle, the apparatus comprising:
a display device configured to display DTE information of a vehicle; and
a controller configured to control operation of the display device,
wherein the controller determines low fuel efficiency-related information and high fuel efficiency-related information based on a current vehicle driving condition, determines a low DTE value and a high DTE value based on the low fuel efficiency-related information, the high fuel efficiency-related information, and a current available battery energy, determines a current DTE value indicating a real-time DTE, and controls operation of the display device to display the low DTE value, the high DTE value, and the current DTE value.

2. The apparatus of claim 1, wherein the controller:
determines, as the low fuel efficiency-related information and the high fuel efficiency-related information, a low-DTE vehicle speed and a high-DTE vehicle speed corresponding to the current vehicle driving condition using information about matching between low-DTE and high-DTE vehicle speeds and a vehicle driving condition; and
determines, as the low fuel efficiency-related information and the high fuel efficiency-related information, a total battery output at the low-DTE vehicle speed and a total battery output at the high-DTE vehicle speed using the low-DTE vehicle speed, the high-DTE vehicle speed, and constant-speed fuel efficiency information of the vehicle.

3. The apparatus of claim 2, wherein the current vehicle driving condition comprises a region condition and a road condition in which the vehicle travels.

4. The apparatus of claim 2, wherein the controller:
determines a driving output necessary to drive the vehicle using the low-DTE vehicle speed, the high-DTE vehicle speed, and the constant-speed fuel efficiency information of the vehicle; and
determines a total battery output at the low-DTE vehicle speed, including the determined driving output, and a total battery output at the high-DTE vehicle speed, including the determined driving output.

5. The apparatus of claim 4, wherein the driving output comprises:
a low-DTE driving output determined to be a value corresponding to the low-DTE vehicle speed; and
a high-DTE driving output determined to be a value corresponding to the high-DTE vehicle speed.

6. The apparatus of claim 5, wherein the total battery output comprises:
a low-DTE total output as the total battery output at the low-DTE vehicle speed, the low-DTE total output being determined to be a value obtained by summing the low-DTE driving output and a current air-conditioning output used for air-conditioning of the vehicle; and
a high-DTE total output as the total battery output at the high-DTE vehicle speed, the high-DTE total output being determined to be a value obtained by summing the high-DTE driving output and the current air-conditioning output.

7. The apparatus of claim 6, wherein:
the low-DTE total output is determined to be a value obtained by adding a converter output to the value obtained by summing the low-DTE driving output and the current air-conditioning output, the converter output being a battery output that is output to electronic components of the vehicle through a converter; and
the high-DTE total output is determined to be a value obtained by adding the converter output to the value obtained by summing the high-DTE driving output and the current air-conditioning output.

8. The apparatus of claim 6, wherein:
the low DTE value is determined to be a value obtained by multiplying a value, obtained by dividing the low-DTE vehicle speed by the low-DTE total output, by the available battery energy; and
the high DTE value is determined to be a value obtained by multiplying a value, obtained by dividing the high-DTE vehicle speed by the high-DTE total output, by the available battery energy.

9. The apparatus of claim 2, wherein:
the low DTE value is determined to be a value obtained by multiplying a value, obtained by dividing the low-DTE vehicle speed by the total battery output at the low-DTE vehicle speed, by the available battery energy; and
the high DTE value is determined to be a value obtained by multiplying a value, obtained by dividing the high-DTE vehicle speed by the total battery output at the high-DTE vehicle speed, by the available battery energy.

10. The apparatus of claim 1, wherein the controller and the display device are configured to display the low DTE value, the high DTE value, and the current DTE value through one or two or more display methods selected from among a numerical value, a display position on a graph image, a size of the graph image, and a color of the graph image so that the low DTE value, the high DTE value, and the current DTE value are compared with each other.

11. The apparatus of claim 10, wherein the controller and the display device are configured such that, as the current DTE value is updated and changed, a display position or a color of the current DTE value in the graph image is changed between a display position or a color of the low DTE value and a display position or a color of the high DTE value and such that the changed display position or color indicates the current DTE value as a value relative to the low DTE value and the high DTE value.

12. A method of providing information on a distance to empty (DTE) of a vehicle, the method comprising:
determining, by a controller, low fuel efficiency-related information and high fuel efficiency-related information based on a current vehicle driving condition;
determining, by the controller, a low DTE value and a high DTE value based on the low fuel efficiency-related information, the high fuel efficiency-related information, and a current available battery energy and determining a current DTE value indicating a real-time DTE; and
controlling, by the controller, operation of a display device to display the low DTE value, the high DTE value, and the current DTE value.

13. The method of claim 12, wherein determining low fuel efficiency-related information and the high fuel efficiency-related information comprises:
determining a low-DTE vehicle speed and a high-DTE vehicle speed corresponding to the current vehicle driving condition using information about matching between low-DTE and high-DTE vehicle speeds and a vehicle driving condition; and
determining a total battery output at the low-DTE vehicle speed and a total battery output at the high-DTE vehicle speed using the low-DTE vehicle speed, the high-DTE vehicle speed, and constant-speed fuel efficiency information of a vehicle.

14. The method of claim 13, wherein determining a total battery output comprises:
determining a driving output necessary to drive the vehicle using the low-DTE vehicle speed, the high-DTE vehicle speed, and the constant-speed fuel efficiency information of the vehicle; and
determining a total battery output at the low-DTE vehicle speed, including the determined driving output, and a total battery output at the high-DTE vehicle speed, including the determined driving output.

15. The method of claim 14, wherein, in determining a driving output, the driving output comprises:
a low-DTE driving output determined to be a value corresponding to the low-DTE vehicle speed; and
a high-DTE driving output determined to be a value corresponding to the high-DTE vehicle speed.

16. The method of claim 15, wherein:
determining a total battery output further comprises determining a current air-conditioning output used for air-conditioning of the vehicle; and
the total battery output includes
a low-DTE total output as the total battery output at the low-DTE vehicle speed, the low-DTE total output being determined to be a value obtained by summing the low-DTE driving output and the current air-conditioning output, and
a high-DTE total output as the total battery output at the high-DTE vehicle speed, the high-DTE total output being determined to be a value obtained by summing the high-DTE driving output and the current air-conditioning output.

17. The method of claim 16, wherein;
determining a total battery output further comprises determining a converter output, the converter output being a battery output that is output to electronic components of the vehicle through a converter; and
the total battery output includes
a low-DTE total output determined to be a value obtained by summing the low-DTE driving output, the air-conditioning output, and the converter output, and
a high-DTE total output determined to be a value obtained by summing the high-DTE driving output, the air-conditioning output, and the converter output.

18. The method of claim 16, wherein, in determining a low DTE value and a high DTE value, the low DTE value is determined to be a value obtained by multiplying a value, obtained by dividing the low-DTE vehicle speed by the low-DTE total output, by the available battery energy, and the high DTE value is determined to be a value obtained by multiplying a value, obtained by dividing the high-DTE vehicle speed by the high-DTE total output, by the available battery energy.

19. The method of claim 13, wherein, in determining a low DTE value and a high DTE value, the low DTE value is determined to be a value obtained by multiplying a value, obtained by dividing the low-DTE vehicle speed by the total battery output at the low-DTE vehicle speed, by the available battery energy, and the high DTE value is determined to be a value obtained by multiplying a value, obtained by dividing the high-DTE vehicle speed by the total battery output at the high-DTE vehicle speed, by the available battery energy.

20. The method of claim 12, wherein, in the controlling operation of a display device, the low DTE value, the high DTE value, and the current DTE value are displayed on the display device through one or two or more display methods selected from among a numerical value, a display position on a graph image, a size of the graph image, and a color of the graph image to be compared with each other.
